(19) United States
(12) Patent Application Publication
(10) Pub. No.: US 2026/0212114 A1
(43) Pub. Date: Jul. 23, 2026

(54) DATA STORAGE CONTROL USING A SPATIAL-SEQUENTIAL GRAPH NETWORK WITH NON-ADJACENT SEQUENTIAL NODE CONNECTIONS

(71) Applicant: Dell Products L.P., Round Rock, TX (US)

(72) Inventors: Zijia Wang, London (GB); Zhen Jia, Shanghai (CN); Qiang Chen, Shanghai (CN); Jing Yu, Shanghai (CN)

(21) Appl. No.: 19/033,977

(22) Filed: Jan. 22, 2025

(51) Int. Cl. G06F 40/194; G06F 16/901

(52) U.S. Cl. CPC G06F 40/194; G06F 16/9024

(57) ABSTRACT

Techniques are provided for data storage control using a spatial-sequential graph network with non-adjacent sequential node connections. One method comprises obtaining portions of a digital file; determining spatial relationships and sequential relationships associated with the digital file; generating a graph representation of the digital file based on the determined spatial relationships and the determined sequential relationships; encoding the determined spatial relationships and the determined sequential relationships from the graph representation into a spatial-sequential graph network comprised of nodes and edges connecting nodes, wherein two non-adjacent nodes in the spatial-sequential graph network are connected in the spatial-sequential graph network based on one or more distance metrics relating to the two non-adjacent nodes; performing similarity detection for the digital file; and initiating an automated data storage control action based on a result of the similarity detection.

### BACKGROUND

The expansion of digital content has led to increased needs for solutions in file similarity detection and data storage control with respect to numerous applications such as, for example, data deduplication, plagiarism detection, malware analysis and digital forensics. Many existing file similarity analysis techniques employ hash functions that provide a significantly different output in response to small input changes.

### SUMMARY

Illustrative embodiments of the disclosure provide techniques for data storage control using a spatial-sequential graph network with non-adjacent sequential node connections. One method includes obtaining a plurality of portions of at least one digital file; determining one or more spatial relationships and one or more sequential relationships associated with the plurality of portions within the at least one digital file; generating at least one graph representation of at least portions of the at least one digital file based at least in part on the one or more determined spatial relationships and the one or more determined sequential relationships; encoding at least some of the one or more determined spatial relationships and at least some of the one or more determined sequential relationships from the at least one graph representation into a spatial-sequential graph network comprised of a plurality of nodes and a plurality of edges connecting two or more of the plurality of nodes, wherein two non-adjacent nodes in the spatial-sequential graph network are connected in the spatial-sequential graph network based at least in part on one or more distance metrics relating to the two non-adjacent nodes; aggregating at least a plurality of the one or more encoded determined spatial relationships and the one or more encoded determined sequential relationships of the at least one graph representation into a spatial-sequential feature representation of the at least one digital file; performing similarity detection for the at least one digital file relative to one or more additional digital files based at least in part on the spatial-sequential feature representation of the at least one digital file; and initiating one or more automated data storage control actions based at least in part on a result of the similarity detection.

Illustrative embodiments can provide significant advantages relative to conventional techniques. For example, technical problems related to such conventional techniques are mitigated in one or more embodiments by employing spatial-sequential graph networks having non-adjacent sequential node connections to bridge separated nodes within sequences of nodes.

These and other illustrative embodiments described herein include, without limitation, methods, apparatus, systems, and computer program products comprising processor-readable storage media.

### BRIEF DESCRIPTION OF THE DRAWINGS

FIG. 1 illustrates an information processing system configured for data storage control using a spatial-sequential graph network with non-adjacent sequential node connections in accordance with an illustrative embodiment;

FIG. 2 illustrates an example system architecture and workflow in accordance with an illustrative embodiment;

FIG. 3 illustrates an example structure of a sequential-aware k-dimensional (SAKD) tree in accordance with an illustrative embodiment;

FIG. 4 illustrates a connection of non-adjacent sequential nodes in accordance with an illustrative embodiment;

FIG. 5 illustrates a merging of features for nodes associated with different time steps in accordance with an illustrative embodiment;

FIG. 6 is a flow diagram illustrating an exemplary implementation of a process for data storage control using a spatial-sequential graph network with non-adjacent sequential node connections in accordance with an illustrative embodiment;

FIG. 7 illustrates an exemplary processing platform that may be used to implement at least a portion of one or more embodiments of the disclosure comprising a cloud infrastructure; and

FIG. 8 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for data storage control using a spatial-sequential graph network with non-adjacent sequential node connections.

As noted above, file similarity detection is a problem in many domains, such as data deduplication, plagiarism detection, malware analysis and digital forensics. Existing methods for file similarity detection can be broadly classified into two categories: hash-based file similarity detection and content-based file similarity detection. Hash-based methods rely on hashing algorithms to generate unique identifiers for files or file chunks. Such hash methods are efficient for exact file search, as they can compare files by comparing their hash values. Hash-based methods, however, are not suitable for fuzzy content search, as they are sensitive to small changes in the file content. For example, changing a single bit in an input file can result in a completely different hash value, making it impossible to detect any similarity between the original and modified files. Moreover, hash-based methods cannot capture the structural and semantic information of files, such as the order and relationship of file chunks.

Content-based methods use various techniques to extract features from files or file chunks, such as n-grams, bag-of-words, term frequency-inverse document frequency (TF-IDF), or deep neural networks. These methods aim to capture at least portions of the content and meaning of files, and measure their similarity based on feature vectors and/or distance metrics. Content-based methods can handle fuzzy content search, as they can tolerate some variations or noise in the file content. Content-based methods, however, are often computationally expensive and require large amounts of data and resources. Furthermore, content-based methods may not be able to capture the spatial and temporal information of files, such as the position and sequence of file chunks.

To address the limitations of existing methods, techniques are provided for encoding and similarity matching of digital files based on a spatial-sequential algorithm to SAKD trees. In some embodiments, the disclosed techniques combine the advantages of hash-based and content-based methods and introduce concepts of spatial and temporal transformers. The disclosed digital file similarity detection techniques detect files that are similar not only in content but also in structure and order, and can adapt to the dynamic nature of digital content.

In one or more embodiments, the disclosed techniques for digital file similarity detection using a spatial-sequential graph network with non-adjacent sequential node connections employ dynamic edge weighting, connections of non-adjacent sequential nodes and/or temporal feature fusion. The disclosed dynamic edge weighting techniques adjust connections between data points based on spatial and temporal relevance, to improve optimal adaptability. The disclosed techniques for connecting non-adjacent sequential (e.g., temporal) nodes bridge distant nodes within sequences, enhancing long-range dependencies. The disclosed temporal feature fusion techniques combine features across time steps, to improve temporal resolution and interpretive depth.

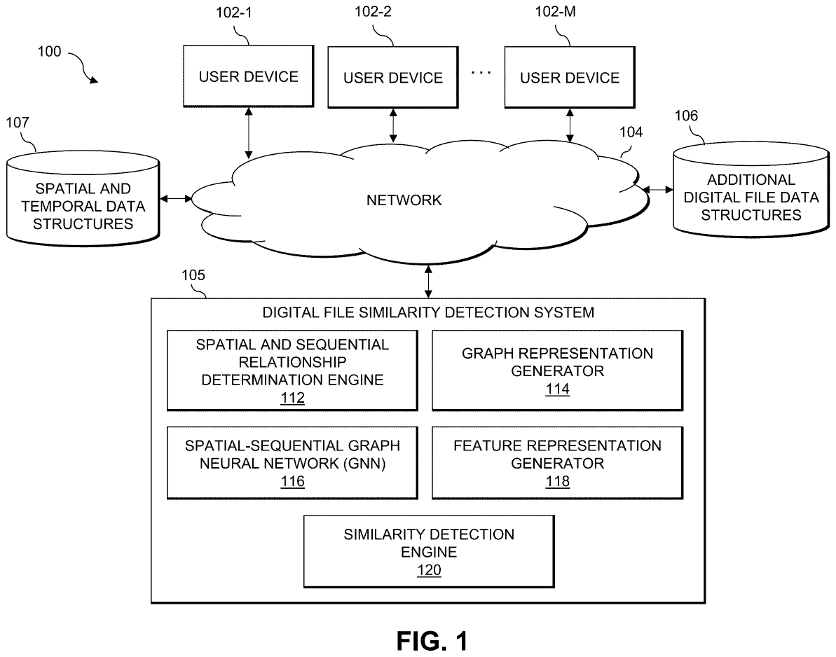

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is digital file similarity detection system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the digital file similarity detection system 105 can have one or more spatial and temporal data structures 107 configured to store data having spatial attributes such as, e.g., coordinates, distances, regions, etc., as well as data that change over time such as, e.g., time series, streams, videos, etc. By way merely of example, spatial and temporal data structures 107 can include one or more SAKD trees, a type of data structure that extends KD-trees with sequential awareness. Additionally, the digital file similarity detection system 105 can have one or more additional digital file data structures 106 configured to store data pertaining to multiple digital files (e.g., digital files which have already been processed for comparison and/or similarity detection operations as detailed herein).

The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The spatial and temporal data structures 107 and additional digital file data structures 106 in the present embodiment are implemented using one or more storage systems associated with the digital file similarity detection system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the digital file similarity detection system 105 are one or more input-output devices, which illustratively comprise keyboards, displays or other types of input-output devices in any combination. Such input-output devices can be used, for example, to support one or more user interfaces to the digital file similarity detection system 105, as well as to support communication between the digital file similarity detection system 105 and other related systems and devices not explicitly shown.

Additionally, the digital file similarity detection system 105 in the FIG. 1 embodiment is assumed to be implemented using at least one processing device. Each such processing device generally comprises at least one processor and an associated memory, and implements one or more functional modules for controlling certain features of the digital file similarity detection system 105.

More particularly, the digital file similarity detection system 105 in this embodiment can comprise a processor coupled to a memory and a network interface.

The processor illustratively comprises a microprocessor, a microcontroller, an application specific integrated circuit (ASIC), a field programmable gate array (FPGA), a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the digital file similarity detection system 105 to communicate over the network 104 with the user devices 102, and illustratively comprises one or more conventional transceivers.

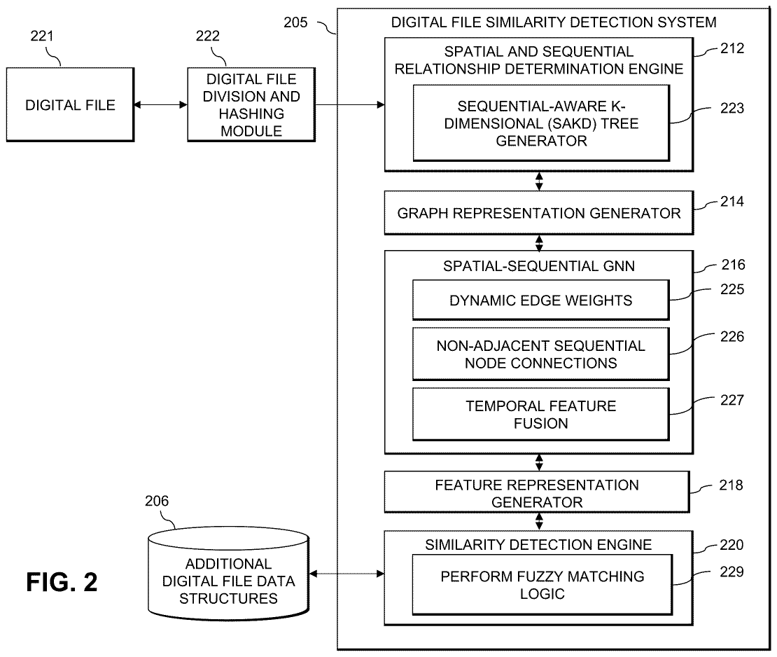

The digital file similarity detection system 105 further comprises spatial and sequential relationship determination engine 112, graph representation generator 114, spatial-sequential graph neural network (GNN) 116, feature representation generator 118 and similarity detection engine 120, each discussed further below in conjunction with FIG. 2.

It is to be appreciated that this particular arrangement of elements 112, 114, 116, 118 and 120 illustrated in the digital file similarity detection system 105 of the FIG. 1 embodiment is presented by way of example only, and alternative arrangements can be used in other embodiments. For example, the functionality associated with elements 112, 114, 116, 118 and 120 in other embodiments can be combined into a single module, or separated across a larger number of modules. As another example, multiple distinct processors can be used to implement different ones of elements 112, 114, 116, 118 and 120 or portions thereof.

At least portions of elements 112, 114, 116, 118 and 120 may be implemented at least in part in the form of software that is stored in memory and executed by a processor.

It is to be understood that the particular set of elements shown in FIG. 1 for data storage control and digital file similarity detection involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of digital file similarity detection system 105, spatial and temporal data structures 107, additional digital file data structures 106, and user devices 102 can be on and/or part of the same processing platform.

An exemplary process utilizing elements 112, 114, 116, 118 and 120 of digital file similarity detection system 105 in computer network 100 will be described in more detail with reference to the diagram of FIG. 2.

Accordingly, at least one embodiment includes encoding and similarity matching of digital files through the development and implementation of at least one spatial-sequential algorithm and SAKD trees, incorporating portions of one or more spatial and temporal transformers.

FIG. 2 shows an example system architecture and workflow in an illustrative embodiment. By way of illustration, FIG. 2 depicts the integration of one or more spatial data structures with sequential (e.g., temporal) and graph-based learning algorithms, enhanced by spatial-temporal transformer techniques, to create a multidimensional representation of files. More particularly, FIG. 2 depicts a digital file division and hashing module 222 that divides a digital file 221 into chunks (also referred to herein as portions) and hashes at least a portion of such chunks. In connection with such division and hashing actions, sequential (e.g., temporal) positions associated with the hashed chunks are determined and provided to spatial and sequential relationship determination engine 212 of digital file similarity detection system 205.

Subsequently, spatial and sequential relationship determination engine 212 comprises an SAKD tree generator 223 that constructs one or more SAKD trees that capture both the spatial relationships of the hashed file chunks and their original sequence within digital file 221. The SAKD trees are then transformed into one or more graph representations by graph representation generator 214, wherein nodes represent file chunks augmented with one or more features derived from hash values and their sequential positions, and edges encode the spatial and temporal relationships between chunks.

Additionally, as depicted in FIG. 2, a spatial-sequential GNN 216, which can include, e.g., at least one spatial-sequential algorithm that employs an adapted GNN architecture, integrates spatial and temporal dynamics through one or more mechanisms to process the graph and update one or more node representations, effectively capturing one or more spatial properties and the sequential order of the data. The spatial-sequential GNN 216 may comprise one or more of dynamic edge weights 225, non-adjacent sequential node connections 226 and temporal feature fusion 227, as discussed herein.

In the example of FIG. 2, feature representation generator 218 performs at least one graph pooling operation that aggregates one or more features of at least a portion of the nodes (e.g., all nodes), and uses such aggregated features to generate a single feature vector, serving as a comprehensive feature representation of digital file 221.

This feature vector facilitates a nuanced approach by fuzzy matching logic 229, implemented by a similarity detection engine 220, enabling the detection of one or more additional digital files (with data related thereto stored in additional digital file data structures 206) that are similar not only in content but also in the structure and order as the content of digital file 221. By way of example, the results of such fuzzy matching logic 229 can be used in various use cases including managing and/or protecting intellectual property, enhancing data organization, improving data deduplication processes, etc., while significantly reducing storage costs and improving and/or ensuring data integrity.

Accordingly, one or more embodiments include using SAKD trees for a multidimensional representation of files that capture spatial and sequential (e.g., temporal) relationships. Also, such an embodiment includes integrating and/or adapting spatial and temporal transformers within a GNN framework to encode these relationships and learn intra-graph and inter-graph dependencies. Further, in such an embodiment, at least one SAKD tree construction algorithm is generated and/or implemented.

Accordingly, one or more embodiments include encoding and similarity matching of digital files based at least in part on implementing a spatial-sequential algorithm in connection with SAKD trees. Such an embodiment includes combining advantages of hash-based similarity detection techniques and content-based similarity detection techniques, while also integrating spatial and temporal transformers.

As such, at least one embodiment can include efficiently and accurately detecting and/or identifying files that are similar not only in content but also in structure and/or order, and can also include adapting to the dynamic nature of digital content. As further detailed herein, such an embodiment includes utilizing spatial data structures in connection with sequential and graph-based learning algorithms, enhanced by spatial-temporal transformer techniques, to create at least one unique, multidimensional representation of files.

As noted above and as further detailed herein, spatial data structures are designed to store and query data having spatial attributes such as, e.g., coordinates, distances, regions, etc. Examples of spatial data structures include quadtrees, octrees, R-trees, and KD-trees. KD-trees, as used herein, refer to binary trees that partition a data space into hyperrectangles along the axes. However, KD-trees may not be suitable for storing and querying data that have temporal attributes, such as timestamps, durations and sequences. Temporal data structures are designed to handle data that change over time, such as time series, streams, or videos. Examples of temporal data structures can include, e.g., B-trees, R*-trees and interval trees. Temporal data structures can support operations such as, e.g., temporal join, aggregation and indexing.

Based at least in part on a desire to capture both spatial and temporal information of digital files and/or content, one or more embodiments include generating and/or implementing SAKD trees, a unique type of data structure that extends KD-trees with sequential awareness. In such an embodiment, SAKD trees divide files into chunks, hash these chunks, and record the sequential positions of at least portions of the chunks. Accordingly, SAKD trees capture both the spatial relationships of file chunks and the original sequence of file chunks within the given file. Additionally, SAKD trees can support efficient and accurate file similarity detection based at least in part on file content and file structure.

As also detailed herein, GNNs are a class of deep learning models that operate on graph-structured data, such as, e.g., social networks, knowledge graphs and molecular graphs. GNNs can learn node and edge representations by aggregating information from local neighborhoods, and can perform various tasks such as, e.g., node classification, link prediction, and graph generation. Examples of GNNs can include graph convolutional networks (GCNs), graph attention networks (GATs) and graph isomorphism networks (GINs).

However, many GNNs are designed for static graphs and cannot handle graphs that change over time, such as, e.g., dynamic networks, temporal graphs and spatio-temporal graphs. Dynamic graph neural networks (DGNNs) can include deep learning models that capture temporal evolution of graph-structured data and perform tasks such as dynamic node classification, link prediction and graph generation. Examples of DGNNs can include recurrent graph neural networks (R-GNNs), temporal graph convolutional networks (T-GCNs), and dynamic graph attention networks (DyGATs).

While conventional GNN models cannot capture both the spatial and temporal information of digital files, at least one embodiment includes generating and/or implementing at least one spatial-sequential algorithm, a unique GNN model that operates on graph representations of files derived from SAKD trees. Such a spatial-sequential algorithm employs an adapted GNN architecture, integrating spatial and temporal dynamics through one or more mechanisms. Also, such a spatial-sequential algorithm can process a graph and update node representations, effectively capturing both the spatial properties and the sequential order of data. Further, such a spatial-sequential algorithm can generate a comprehensive feature vector for each file, facilitating a nuanced approach to fuzzy similarity matching.

As also detailed herein, transformers refer to a class of deep learning models that use one or more self-attention mechanisms to encode and decode sequential data (such as, e.g., natural language data, speech data and music data). Transformers can capture long-range dependencies and patterns in sequential data, and can perform tasks such as machine translation, text summarization, and natural language generation.

However, many transformers are designed for one-dimensional sequential data, and cannot handle data with spatial dimensions, such as images, videos and point clouds. Accordingly, spatial transformers refer to a class of deep learning models that use one or more self-attention mechanisms to encode and decode spatial data, and can perform tasks such as image classification, object detection and image generation.

While conventional transformer models cannot capture the spatial and temporal information of digital files, one or more embodiments include generating and/or implementing at least one spatial-temporal transformer, a unique type of transformer model that enhances at least one spatial-sequential algorithm (such as detailed above) with one or more spatial-temporal transformer techniques. Such a spatial-temporal transformer can learn spatial and temporal features from the graph representations of files, and can perform self-attention and cross-attention across different file chunks and/or different files. Also, such a spatial-temporal transformer can improve the quality and robustness of the feature vectors generated by the at least one spatial-sequential algorithm, and can enable more accurate and efficient file similarity detection based at least in part on providing a multidimensional representation of files.

As further detailed herein, one or more embodiments include file division and hashing, SAKD tree construction, graph representation and feature engineering, spatial-sequential GNN encoding, spatial-temporal transformer integration, graph pooling and feature vector generation, and fuzzy similarity matching.

More particularly, such an embodiment includes dividing files into chunks and hashing at least a portion of the chunks, followed by the construction of one or more SAKD trees to capture spatial and sequential relationships across at least a portion of the hashed chunks. At least a portion of the SAKD trees is then transformed into one or more graph representations, which are processed by at least one spatial-sequential GNN and enhanced using one or more spatial-temporal transformer techniques. Further, at least one graph pooling operation is implemented to aggregate node features into one or more comprehensive feature vectors, facilitating nuanced fuzzy similarity matching.

At least one embodiment can include utilizing naïve file division and hashing techniques. Given a digital file F, such an embodiment includes dividing digital file F into N chunks, wherein each chunk Cᵢ represents a segment of the digital file F. This division is based at least in part on a predetermined chunk size, s, to ensure uniformity in processing. Each chunk is then hashed using a cryptographic hash function, H, to generate a unique identifier, hᵢ, for each chunk, such as illustrated via Equation (1) as follows:

$${h}_{i} = H ( {C}_{i} ) ∀ i ∈ \{ 1 , ... , N \} \qquad ( 1 )$$

wherein the hash values hᵢ serve as a compact representation of the content of each file chunk, facilitating efficient similarity checks while preserving the privacy and security of the file content.

To encode sequential information in the original files, at least one embodiment provides a unique tree structure referred to herein as a SAKD tree, a data structure that extends KD trees with sequential awareness to capture both the spatial relationships of file chunks and their original sequence within the given file.

To construct a SAKD tree for a file F with hashed chunks {h₁, h₂, . . . , h_{N}}, at least one embodiment includes considering each hash value hᵢ as a point in a high-dimensional space, wherein the dimensionality corresponds to the hash size. The sequential position of each chunk, denoted as post, is integrated into the tree as an item of auxiliary information.

In one or more embodiments, SAKD tree construction can follow a recursive partitioning process, wherein at each node, the dataset is split based at least in part on the median value of the selected dimension. Unlike conventional KD trees, a SAKD tree incorporates pos; to maintain sequential information of each file chunk. The integration of sequential information pos; into SAKD trees enables maintenance of file chunk order, enriching the tree with spatial and sequential (e.g., temporal) awareness.

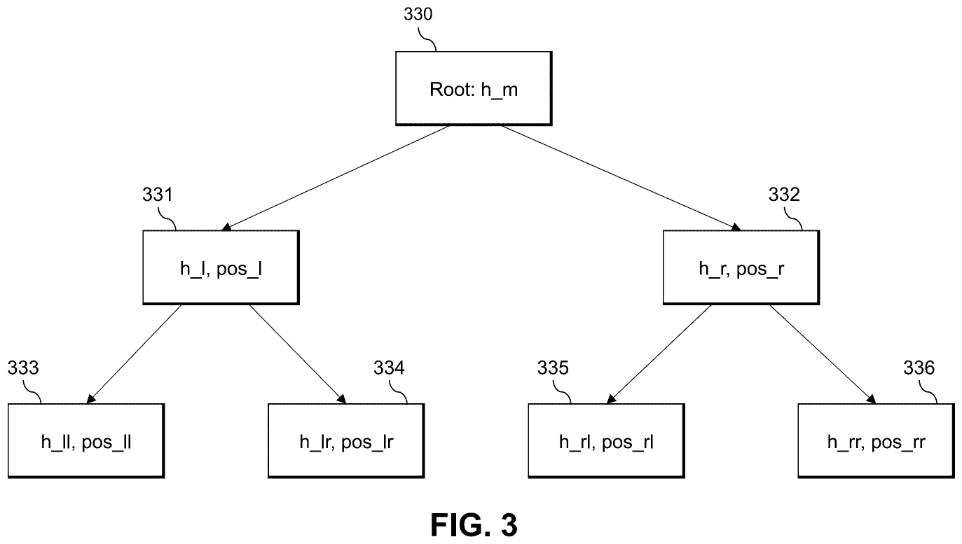

FIG. 3 shows an example structure of a SAKD tree in an illustrative embodiment. By way of illustration, FIG. 3 depicts a root element 330 representing a hashed middle chunk (h_m) of the split dataset of a given digital file. From root element 330, the SAKD tree branches to element 331 representing a hashed chunk of the given digital file from a position left of root element 330 (h_l, pos_l). From root element 330, the SAKD tree also branches to element 332 representing a hashed chunk of the given digital file from a position right of root element 330 (h_r, pos_r).

From element 331, the SAKD tree further branches to element 333 representing a hashed chunk from a position left of element 331 (h_ll, pos_ll), as well as to element 334 representing a hashed chunk from a position right of element 331 (h_lr, pos_lr). Additionally, as depicted in FIG. 3, from element 332, the SAKD tree further branches to element 335 representing a hashed chunk from a position left of element 332 (h_rl, pos_rl), as well as to element 336 representing a hashed chunk from a position right of element 332 (h_rr, pos_rr).

In connection with constructing SAKD trees, one or more embodiments include implementing techniques for using SAKD trees in file indexing for data protection. For example, after constructing SAKD trees, at least one embodiment can include transforming these trees into graph representations and engineering features for nodes and edges to facilitate deep learning-based processing. Additionally, each SAKD tree can be transformed into a graph G=(V, E), wherein V represents the set of vertices (or nodes) and E represents the set of edges. Each node vᵢ ∈V corresponds to a file chunk, characterized by its hash hᵢ and position posᵢ. Also, in such an embodiment, edges (vᵢ, vⱼ)∈E can be defined based at least in part on the spatial proximity and sequential relationship of the chunks, capturing both the structural and temporal relationships within the file.

Also, for each node vᵢ, at least one embodiment can include engineering a feature vector fᵢ that encapsulates both the hash information and the positional information of the corresponding file chunk, such as illustrated in Equation (2) as follows:

$${f}_{i} = [ Embed ( {h}_{i} ) ; Encode ( {pos}_{i} ) ] \qquad ( 2 )$$

wherein Embed (hᵢ) represents an embedding of the hash value hᵢ, converting hash value hᵢ into a dense vector. Also, Encode (posᵢ) represents an encoding of the position posᵢ, which may involve a positional encoding technique similar to those used in one or more transformers to maintain sequential information.

In one or more embodiments, edges are also enriched with one or more features to represent the type and strength of connections between nodes. Such an embodiment can include, for example, incorporating distance metrics and/or similarity measures based at least in part on the hashes and positions of the connected chunks.

With the graph representation of files, one or more embodiments include leveraging a spatial-sequential GNN to encode spatial and sequential information embedded within the graph. In such an embodiment, a GNN architecture is designed and/or implemented to process the nodes and edges of the graph, iteratively updating one or more node features based on local neighborhood information. The update rule for a node vᵢ at layer l+1 is given in Equation (3) as follows:

$${h}_{i}^{( l + 1 )} = {UPDATE}^{( l )} ( {h}_{i}^{( l )} , {AGGREGATE}^{( l )} ( \{ {h}_{j}^{( l )} : j ∈ 𝒩 ( i ) \} ) ) \qquad ( 3 )$$

wherein

$${h}_{i}^{( l )}$$

is the feature vector of node vᵢ at layer l, [symbol] (i) denotes the set of neighbors of vᵢ, AGGREGATE^{(l)} is an aggregation function (such as, e.g., mean, sum, max, etc.) that combines features from vᵢ's neighbors, and UPDATE^{(l)} is an update function (e.g., a neural network layer) that updates vᵢ's feature based at least in part on its own features and one or more aggregated neighbor features.

Additionally or alternatively, at least one embodiment can include implementing an enhanced GNN model architecture that explicitly incorporates sequential information within its update and aggregate functions, to facilitate handling spatial relationships and sequential dynamics within file graphs. For example, to incorporate sequential information, the update and aggregate functions can be modified to leverage the sequential position parameter post of each node, allowing the model to consider the original order of file chunks during processing. This can be achieved by introducing a positional encoding to each node's feature, similar to the techniques used in one or more transformers, and by designing the aggregate function to weigh contributions from neighbors based at least in part on their sequential positions.

For an aggregate function with sequential awareness, the modified aggregate function,

$${AGGREGATE}_{seq}^{( l )} ,$$

incorporates the sequential distance between nodes as a factor in the aggregation process, such as illustrated in Equation (4) as follows:

$${AGGREGATE}_{seq}^{( l )} = {\sum }_{j ∈ 𝒩 ( i )} {w}_{ij} \cdot {h}_{j}^{( l )} \qquad ( 4 )$$

wherein wᵢⱼ is a weight that decreases with increasing sequential distance between nodes i and j, emphasizing closer sequential neighbors more heavily in the aggregation.

In at least one embodiment, the update function integrates one or more spatial-temporal attention mechanisms, enabling the model to dynamically adjust the influence of spatial and sequential information based on the context, as illustrated in Equation (5) as follows:

$${h}_{i}^{( l + 1 )} = {UPDATE}_{STAR}^{( l )} ( {h}_{i}^{( l )} , {AGGREGATE}_{seq}^{( l )} ) \qquad ( 5 )$$

wherein the

$${UPDATE}_{STAR}^{( l )}$$

function uses a combination of self-attention for spatial processing and cross-attention mechanisms for capturing temporal dynamics, effectively learning from both the current state of a node and its evolution over time. Accordingly, this function, termed

$${UPDATE}_{STAR}^{( l )} ,$$

leverages spatial-temporal attention mechanisms to adaptively process interactions between nodes, considering their content, spatial relationships and sequential order.

More particularly, the

$${UPDATE}_{STAR}^{( l )}$$

function utilizes a combination of self-attention and cross-attention mechanisms, drawing inspiration from at least one transformer architecture, to process nodes in a graph. The self-attention component focuses on capturing one or more spatial relationships between nodes (also referred to herein as file chunks). For each node i, a self-attention mechanism computes attention scores with all other nodes j in its neighborhood [symbol] (i), based on their feature vectors

$${h}_{i}^{( l )} and {h}_{j}^{( l )} .$$

This allows the model to dynamically prioritize one or more nodes based at least in part on their spatial relevance to i, enhancing the model's ability to understand spatial structures within the file.

In one or more embodiments, the attention score between nodes i and j can be computed using Equation (6) as follows:

$${α}_{ij} = \frac{exp ( LeakyReLU ( {a}^{T} [ {Wh}_{i}^{( l )} \vert \vert {Wh}_{j}^{( l )} ] ) )}{{Σ}_{k ∈ 𝒩 ( i )} exp ( LeakyReLU ( {a}^{T} [ {Wh}_{i}^{( l )} \vert \vert {Wh}_{k}^{( l )} ] ) )} \qquad ( 6 )$$

wherein a^{T} is a learnable weight vector, W is a learnable weight matrix applied to the node features, and ∥ denotes concatenation. The LeakyReLU nonlinearity introduces a gradient when the unit is not active, helping prevent a dying rectified linear unit (ReLU) problem.

The cross-attention component can be designed to capture sequential dynamics by allowing each node to attend to other nodes based at least in part on their sequential positions. This can be particularly important for understanding how the role and/or importance of an item of information may evolve over the sequence of file chunks. In at least one embodiment, in the cross-attention step, for each node i, attention scores are computed based at least in part on the current feature representations and incorporation of the encoded sequential positions posᵢ and posⱼ, enhancing the model's ability to capture temporal sequences and dependencies between file chunks.

Additionally, one or more embodiments include implementing a feature update with spatial-temporal context. In such an embodiment, after computing the attention scores, the

$${UPDATE}_{STAR}^{( l )}$$

function updates the feature vector of each node by aggregating the features of its neighbors, weighted by the computed attention scores, and then combines this aggregated information with the node's own features to produce a new feature vector

$${h}_{i}^{( l + 1 )} ,$$

such as detailed in Equation (7) as follows:

$${h}_{i}^{( l + 1 )} = COMBINE ( {h}_{i}^{( l )} , {\sum }_{j ∈ 𝒩 ( i )} {α}_{ij} \cdot {Wh}_{j}^{( l )} ) \qquad ( 7 )$$

wherein the COMBINE operation can include, e.g., a concatenation followed by a linear layer, mechanisms such as gating or residual connections, etc., to integrate spatial and temporal information.

To aggregate enhanced node features into a single feature vector, one or more embodiments can include employing advanced graph pooling techniques such as, e.g., global attention pooling and hierarchical pooling. Global attention pooling includes at least one learnable global attention mechanism that weighs nodes based at least in part on their importance to the overall file representation, focusing on chunks that define the file's uniqueness. Also, hierarchical pooling includes implementing at least one approach that progressively aggregates node features at multiple levels, preserving structural and sequential information in the pooled representation.

In at least one embodiment, the pooled graph representation is then transformed into a feature vector for each file, capturing the file's spatial-sequential essence. This vector serves as a comprehensive representation of the file, ready for similarity comparisons and/or analysis.

In one or more embodiments, such similarity comparisons and/or analysis can include performing fuzzy similarity matching. In such an embodiment, comparing the feature vectors of files can include utilizing metrics that consider both the magnitude and orientation of vectors, such as, e.g., cosine similarity, which measures the cosine of the angle between two vectors, useful for determining the similarity in orientation, independent of magnitude, and Euclidean distance, which computes the straight-line distance between two vectors, useful for understanding the absolute difference in their features.

A comparison and/or matching process can involve comparing the feature vector of a query file against one or more vectors in at least one database, identifying one or more files with the highest similarity scores to the query file as potential matches. Such an approach enables the detection of files that are not only similar in content but also in their structural and/or sequential makeup, offering a more granular view of file similarity.

In one or more embodiments, dynamic edge weighting techniques are employed that adjust a weight of one or more connections (e.g., edges) between nodes (e.g., data points) in a spatial-sequential GNN based on spatial and temporal relevance (e.g., to improve adaptability). The edge weights in a spatial-sequential GNN may be adjusted based on (i) a similarity distance between at least two nodes, associated with at least one edge, and/or (ii) a time distance between at least two nodes associated with at least one edge. The dynamic edge weights,

$${W}_{ij}^{( l )} ,$$

that allow for the adaptive modulation of connectivity (e.g., varying levels of importance) between nodes, i and j, for a current time step, l, in the spatial-sequential GNN may be determined as follows:

$${W}_{ij}^{( l )} = exp ( - {α}^{( l )} \cdot {d}_{ij} + {β}^{( l )} Δ {t}_{ij} ) , \qquad ( 8 )$$

where dᵢⱼ is a similarity distance, Δtᵢⱼ is a time-based sequential discrepancy (e.g., a time difference between frames) and α^{(l)} and β^{(l)} are parameters (e.g., learned from training data, where β^{(l)} can have a higher value to emphasize temporal aspects and α^{(l)} can have a higher value to emphasize spatial aspects, for example). In this manner, the dynamic edge weights reflect the varying significance of spatial proximity and temporal sequence across different contexts, providing sensitivity to the distinct nature of the data structure of each file.

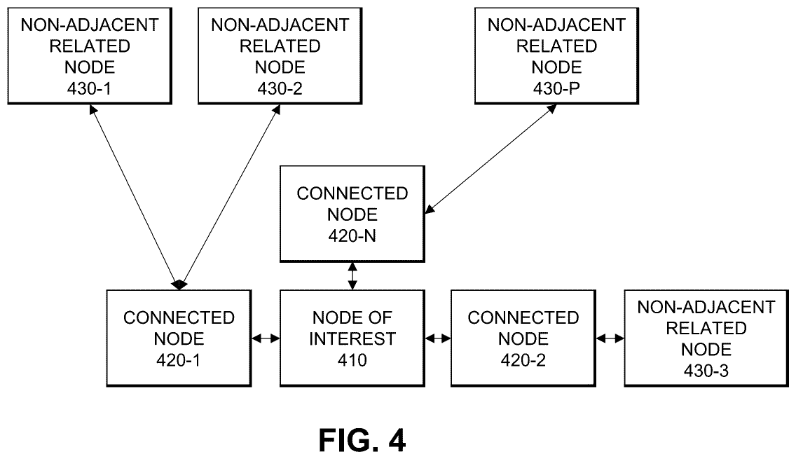

FIG. 4 illustrates a connection of non-adjacent sequential nodes in accordance with an illustrative embodiment. As noted above, the disclosed techniques for connecting non-adjacent sequential (e.g., semantically similar) nodes bridge distant nodes within sequences, enhancing long-range dependencies. For example, the non-adjacent sequential nodes may comprise semantically similar nodes from different frames. In the example of FIG. 4, a node of interest 410 from a spatial-sequential GNN is connected to connected nodes 420-1 through 420-N. The connected nodes 420 are often said to be in an original layer. The spatial-sequential GNN also comprises a plurality of non-adjacent related nodes 430-1 through 430-P (e.g., that are not connected to the node of interest 410) that are part of a connected layer. Non-adjacent sequential nodes in the spatial-sequential GNN may be connected based on a determination of a feature value,

$${F}_{i}^{( l + 1 )} ,$$

for a node, i, for a next time step, l+1, as follows:

$${F}_{i}^{( l + 1 )} = {F}_{i}^{( l + 1 )} + {\sum }_{k ∈ 𝒮 ( i )} {W}_{ik}^{( l )} {F}_{k}^{( l )} , \qquad ( 9 )$$

where

$${W}_{ik}^{( l )}$$

comprise ule adjusted weighs of an edge between nodes, i and k, for a current time step, l, and S(i) identifies a set of nodes sequentially close to node i. The feature value,

$${F}_{k}^{( l )} ,$$

for a current time step, l, is determined for values of k within the set of nodes, S(i). In at least some embodiments, a non-zero value of

$${W}_{ik}^{( l )}$$

indicates an influence on the node of interest 410. In this embodiments, a non-zero value of manner, direct links can be established between non-adjacent, sequentially proximate nodes, to enable the GNN to effectively capture long-range dependencies and enhance an understanding of the sequential structure of a file.

Fuzzy similarity matching techniques leverage the encoded feature vectors to identify file similarities, employing a fuzzy logic-based approach to account for minor discrepancies and variations, thus ensuring a more nuanced and flexible similarity detection process. Fuzzy similarity matching operates, in some embodiments, on the principle that files need not be identical but rather can be sufficiently similar (e.g., within a defined tolerance level) to be considered matches. Given two files, Fₐ, F_{b}, with their corresponding encoded feature vectors Vₐ, V_{b} generated by the disclosed GNN, the similarity score, SM(Fₐ, F_{b}), may be calculated as follows:

$$SM ( {F}_{a} , {F}_{b} ) = \frac{1}{1 + d ( {V}_{a} , {V}_{b} )} , \qquad ( 10 )$$

where d(Vₐ, V_{b}) denotes a distance between the feature vectors of the two files, measured using an appropriate metric such as Euclidean distance or cosine similarity. In at least some embodiments, the similarity score SM(Fₐ, F_{b}) ranges between 0 and 1, where 1 indicates perfect similarity and values approaching 0 represent increasing dissimilarity.

The integration of such fuzzy similarity matching techniques into the disclosed digital file similarity detection system enhances an ability to discern and quantify the similarity between files with high precision. This method is particularly effective, for example, in environments where files may undergo minor edits or variations, ensuring that such changes do not disproportionately affect the overall similarity assessment.

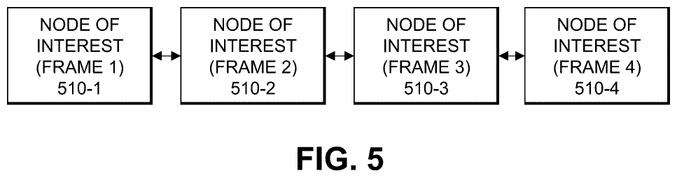

FIG. 5 illustrates a merging of features for nodes associated with different time steps in accordance with an illustrative embodiment. In the example of FIG. 5, a node of interest (e.g., a given feature) 510-1 through 510-4 is shown across four different frames. The given feature,

$${F}_{i}^{( l + 1 )} ,$$

can be merged across the multiple frames or time steps as follows:

$${F}_{i}^{( l + 1 )} = {γ}^{( l )} \cdot {F}_{i}^{( l + 1 )} + ( 1 - {γ}^{( l )} ) \cdot {\sum }_{t = 1}^{T} {ω}_{t}^{( l )} {F}_{i , t}^{( l )} , \qquad ( 11 )$$

where γ^{(l)} and

$${ω}_{t}^{( l )}$$

are parameters to balance and/or emphasize the relevance of historical and current features, respectively.

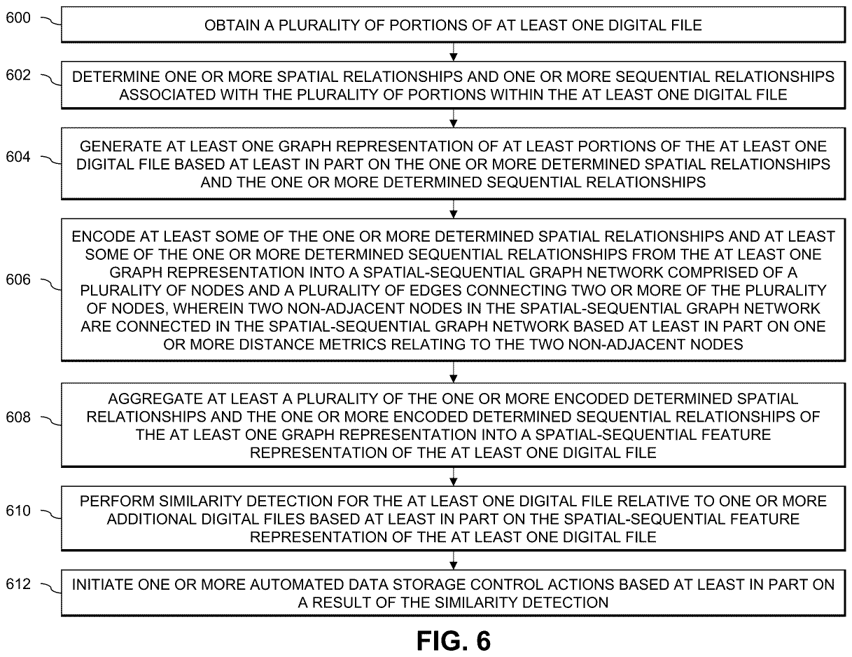

FIG. 6 is a flow diagram illustrating an exemplary implementation of a process for data storage control using a spatial-sequential graph network with non-adjacent sequential node connections in accordance with an illustrative embodiment. In the example of FIG. 6, a plurality of portions of at least one digital file is obtained in step 600. One or more spatial relationships and one or more sequential relationships associated with the plurality of portions within the at least one digital file are determined in step 602.

In step 604, at least one graph representation of at least portions of the at least one digital file is generated based at least in part on the one or more determined spatial relationships and the one or more determined sequential relationships. At least some of the one or more determined spatial relationships and at least some of the one or more determined sequential relationships from the at least one graph representation are encoded in step 606 into a spatial-sequential graph network comprised of a plurality of nodes and a plurality of edges connecting two or more of the plurality of nodes, wherein two non-adjacent nodes in the spatial-sequential graph network are connected in the spatial-sequential graph network based at least in part on one or more distance metrics relating to the two non-adjacent nodes (e.g., (i) a similarity distance metric between the two non-adjacent nodes and/or (ii) a temporal distance metric between the two non-adjacent nodes).

At least a plurality of the one or more encoded determined spatial relationships and the one or more encoded determined sequential relationships of the at least one graph representation is aggregated into a spatial-sequential feature representation of the at least one digital file in step 608.

A similarity detection is performed in step 610 for the at least one digital file relative to one or more additional digital files based at least in part on the spatial-sequential feature representation of the at least one digital file. One or more automated data storage control actions are initiated in step 612 based at least in part on a result of the similarity detection.

In at least one embodiment, the process of FIG. 6 further comprises adjusting a weight of at least one of the plurality of edges in the spatial-sequential graph network based at least in part on one or more of (i) the similarity distance between at least two nodes, associated with the at least one edge, of the plurality of nodes in the spatial-sequential graph network and (ii) the temporal distance between the at least two nodes associated with the at least one edge. The process of FIG. 6 may further comprise merging at least one feature across a plurality of time steps in the spatial-sequential graph network. The determining the one or more spatial relationships and the one or more sequential relationships associated with the plurality of portions within the at least one digital file may comprise generating one or more sequential-aware k-dimensional trees representing one or more of the plurality of portions of the at least one digital file.

In one or more embodiments, the encoding the at least some of the one or more determined spatial relationships and the at least some of the one or more determined sequential relationships from the at least one graph representation into the spatial-sequential graph network comprises processing one or more portions of the at least one graph representation using at least one graph network in connection with one or more spatial-temporal transformers. The performing the similarity detection for the at least one digital file relative to the one or more additional digital files may comprise using one or more machine learning-based fuzzy similarity matching techniques. The performing the similarity detection for the at least one digital file relative to the one or more additional digital files may comprise detecting similarities with respect to digital file content and at least one of digital file content structure and digital file content sequence.

In some embodiments, the process of FIG. 6 further comprises dividing the at least one digital file into the plurality of portions; and hashing the plurality of portions of the at least one digital file. The initiating the one or more automated data storage control actions may comprise classifying the at least one digital file as comprising confidential information, generating one or more notifications related to the result of the similarity detection; generating one or more signals related to the result of the similarity detection; providing information characterizing the result of the similarity detection; and/or controlling a performance of at least one action in another system using the result of the similarity detection.

The particular processing operations and other network functionality described in conjunction with FIGS. 2 through 6, for example, are presented by way of illustrative example only, and should not be construed as limiting the scope of the disclosure in any way. Alternative embodiments can use other types of processing operations for data storage control using a spatial-sequential graph network with non-adjacent sequential node connections. For example, the ordering of the process steps may be varied in other embodiments, or certain steps may be performed concurrently with one another rather than serially. In one aspect, the process can skip one or more of the steps. In other aspects, one or more of the steps are performed simultaneously. In some aspects, additional steps can be performed.

One or more embodiments of the disclosure provide improved methods, apparatus and computer program products for data storage control using a spatial-sequential graph network with non-adjacent sequential node connections. The foregoing applications and associated embodiments should be considered as illustrative only, and numerous other embodiments can be configured using the techniques disclosed herein, in a wide variety of different applications.

In one or more embodiments, the disclosed techniques for data storage control using a spatial-sequential graph network with non-adjacent sequential node connections employ dynamic edge weighting, connections of non-adjacent sequential nodes and/or temporal feature fusion. The disclosed dynamic edge weighting techniques adjust connections between data points based on spatial and temporal relevance, to improve optimal adaptability. The disclosed techniques for connecting non-adjacent sequential nodes bridge distant nodes within sequences, enhancing long-range dependencies. The disclosed temporal feature fusion techniques combine features across time steps, to improve temporal resolution and interpretive depth.

It should also be understood that the disclosed techniques for data storage control using a spatial-sequential graph network with non-adjacent sequential node connections, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for data storage control using a spatial-sequential graph network with non-adjacent sequential node connections may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute and/or storage services can be offered to cloud infrastructure tenants or other system users as a PaaS, IaaS, STaaS and/or FaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based digital file similarity detection engine, or portions thereof, are illustratively implemented for use by tenants of such a multi-tenant environment.

Cloud infrastructure as disclosed herein can include cloud-based systems. Virtual machines provided in such systems can be used to implement at least portions of a cloud-based digital file similarity detection platform in illustrative embodiments. The cloud-based systems can include object stores.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

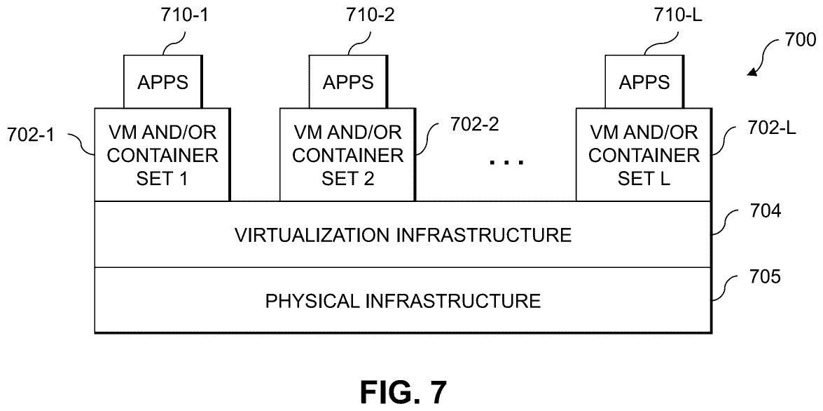

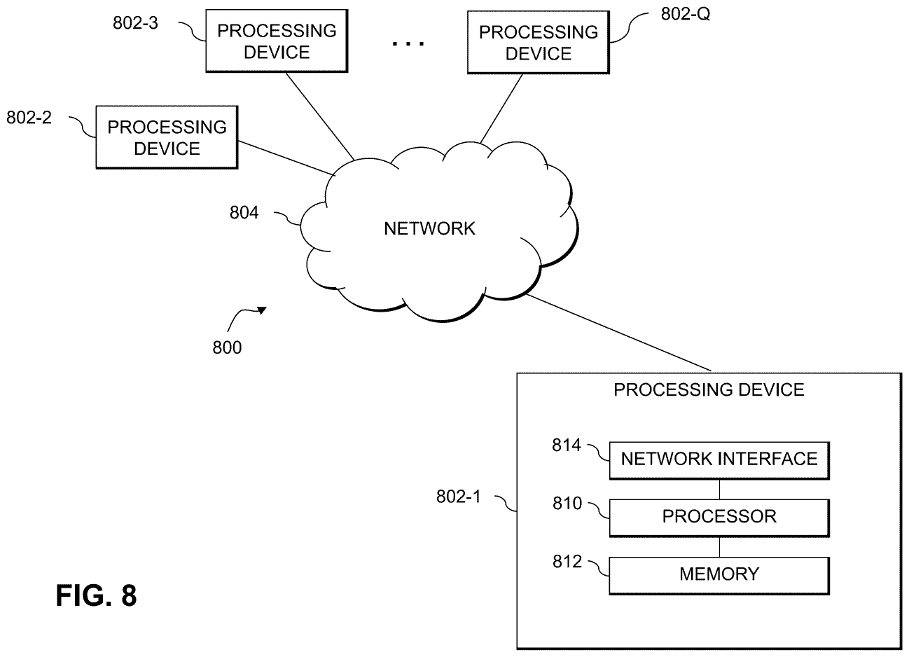

Illustrative embodiments of processing platforms will now be described in greater detail with reference to FIGS. 7 and 8. These platforms may also be used to implement at least portions of other information processing systems in other embodiments.

FIG. 7 shows an example processing platform comprising cloud infrastructure 700. The cloud infrastructure 700 comprises a combination of physical and virtual processing resources that may be utilized to implement at least a portion of the information processing system 100. The cloud infrastructure 700 comprises multiple virtual machines (VMs) and/or container sets 702-1, 702-2, . . . 702-L implemented using virtualization infrastructure 704. The virtualization infrastructure 704 runs on physical infrastructure 705, and illustratively comprises one or more hypervisors and/or operating system level virtualization infrastructure. The operating system level virtualization infrastructure illustratively comprises kernel control groups of a Linux operating system or other type of operating system.

The cloud infrastructure 700 further comprises sets of applications 710-1, 710-2, . . . 710-L running on respective ones of the VMs/container sets 702-1, 702-2, . . . 702-L under the control of the virtualization infrastructure 704. The VMs/container sets 702 may comprise respective VMs, respective sets of one or more containers, or respective sets of one or more containers running in VMs.

In some implementations of the FIG. 7 embodiment, the VMs/container sets 702 comprise respective VMs implemented using virtualization infrastructure 704 that comprises at least one hypervisor. Such implementations can provide chat assistant adaptation functionality of the type described above for one or more processes running on a given one of the VMs. For example, each of the VMs can implement digital file similarity detection control logic and associated functionality for processing spatial-sequential graph neural networks.

An example of a hypervisor platform that may be used to implement a hypervisor within the virtualization infrastructure 704 is a compute virtualization platform which may have an associated virtual infrastructure management system such as server management software. The underlying physical machines may comprise one or more distributed processing platforms that include one or more storage systems.

In other implementations of the FIG. 7 embodiment, the VMs/container sets 702 comprise respective containers implemented using virtualization infrastructure 704 that provides operating system level virtualization functionality, such as support for Docker containers running on bare metal hosts, or Docker containers running on VMs. The containers are illustratively implemented using respective kernel control groups of the operating system. Such implementations can provide chat assistant adaptation functionality of the type described above for one or more processes running on different ones of the containers. For example, a container host device supporting multiple containers of one or more container sets can implement one or more instances of digital file similarity detection control logic and associated functionality for processing spatial-sequential graph neural networks.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 700 shown in FIG. 7 may represent at least a portion of one processing platform. Another example of such a processing platform is processing platform 800 shown in FIG. 8.

The processing platform 800 in this embodiment comprises at least a portion of the given system and includes a plurality of processing devices, denoted 802-1, 802-2, 802-3, . . . 802-Q, which communicate with one another over a network 804. The network 804 may comprise any type of network, such as a WAN, a LAN, a satellite network, a telephone or cable network, a cellular network, a wireless network such as WiFi or WiMAX, or various portions or combinations of these and other types of networks.

The processing device 802-1 in the processing platform 800 comprises a processor 810 coupled to a memory 812. The processor 810 may comprise a microprocessor, a microcontroller, an ASIC, an FPGA, a CPU, a GPU, a TPU, a VPU, a NPU, a DPU, an SOC or other type of processing circuitry, as well as portions or combinations of such circuitry elements, and the memory 812, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 802-1 is network interface circuitry 814, which is used to interface the processing device with the network 804 and other system components, and may comprise conventional transceivers.

The other processing devices 802 of the processing platform 800 are assumed to be configured in a manner similar to that shown for processing device 802-1 in the figure.

Again, the particular processing platform 800 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 7 or 8, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

1. A computer-implemented method comprising:
obtaining a plurality of portions of at least one digital file;
determining one or more spatial relationships and one or more sequential relationships associated with the plurality of portions within the at least one digital file;
generating at least one graph representation of at least portions of the at least one digital file based at least in part on the one or more determined spatial relationships within the at least one digital file and the one or more determined sequential relationships within the at least one digital file, wherein graph nodes in the at least one graph representation represent portions of the at least one digital file, wherein a given graph node is augmented with (i) one or more feature values derived from at least one hash value of the corresponding portion of the at least one digital file and (ii) a sequential position of the corresponding portion, and wherein a graph edge between at least two graph nodes encodes the one or more determined spatial relationships between the corresponding portions and the one or more determined sequential relationships between the corresponding portions;
encoding at least some of the one or more determined spatial relationships and at least some of the one or more determined sequential relationships from the at least one graph representation into a spatial-sequential graph network comprised of a plurality of network nodes and a plurality of network edges connecting two or more of the plurality of network nodes by processing one or more portions of the at least one graph representation using at least one graph network in connection with one or more processor-based spatial-temporal transformers, wherein two non-adjacent network nodes in the spatial-sequential graph network are connected in the spatial-sequential graph network based at least in part on one or more distance metrics relating to the two non-adjacent network nodes;
aggregating at least a plurality of the one or more encoded determined spatial relationships and the one or more encoded determined sequential relationships of the at least one graph representation into a spatial-sequential feature representation of the at least one digital file;
performing similarity detection for the at least one digital file relative to one or more additional digital files based at least in part on the spatial-sequential feature representation of the at least one digital file; and
initiating one or more automated data storage control actions based at least in part on a result of the similarity detection;
wherein the method is performed by at least one processing device comprising a processor coupled to a memory.

2. The computer-implemented method of claim 1, further comprising adjusting a weight of at least one of the plurality of network edges in the spatial-sequential graph network based at least in part on one or more of (i) the similarity distance between at least two network nodes, associated with the at least one network edge, of the plurality of network nodes in the spatial-sequential graph network and (ii) the temporal distance between the at least two network nodes associated with the at least one network edge.

3. The computer-implemented method of claim 1, further comprising merging at least one feature across a plurality of time steps in the spatial-sequential graph network.

4. The computer-implemented method of claim 1, wherein the determining the one or more spatial relationships and the one or more sequential relationships associated with the plurality of portions within the at least one digital file comprises generating one or more sequential-aware k-dimensional trees representing one or more of the plurality of portions of the at least one digital file.

5. (canceled)

6. The computer-implemented method of claim 1, wherein the performing the similarity detection for the at least one digital file relative to the one or more additional digital files comprises using one or more machine learning-based fuzzy similarity matching techniques.

7. The computer-implemented method of claim 1, wherein the performing the similarity detection for the at least one digital file relative to the one or more additional digital files comprises detecting similarities with respect to digital file content and at least one of digital file content structure and digital file content sequence.

8. The computer-implemented method of claim 1, further comprising:
dividing the at least one digital file into the plurality of portions; and
hashing the plurality of portions of the at least one digital file.

9. The computer-implemented method of claim 1, wherein the initiating the one or more automated data storage control actions comprises one or more of classifying the at least one digital file as comprising confidential information, generating one or more notifications related to the result of the similarity detection; generating one or more signals related to the result of the similarity detection; providing information characterizing the result of the similarity detection; and controlling a performance of at least one action in another system using the result of the similarity detection.

10. A non-transitory processor-readable storage medium having stored therein program code of one or more software programs, wherein the program code when executed by at least one processing device causes the at least one processing device:
obtaining a plurality of portions of at least one digital file;
determining one or more spatial relationships and one or more sequential relationships associated with the plurality of portions within the at least one digital file;
generating at least one graph representation of at least portions of the at least one digital file based at least in part on the one or more determined spatial relationships within the at least one digital file and the one or more determined sequential relationships within the at least one digital file, wherein graph nodes in the at least one graph representation represent portions of the at least one digital file, wherein a given graph node is augmented with (i) one or more feature values derived from at least one hash value of the corresponding portion of the at least one digital file and (ii) a sequential position of the corresponding portion, and wherein a graph edge between at least two graph nodes encodes the one or more determined spatial relationships between the corresponding portions and the one or more determined sequential relationships between the corresponding portions;
encoding at least some of the one or more determined spatial relationships and at least some of the one or more determined sequential relationships from the at least one graph representation into a spatial-sequential graph network comprised of a plurality of network nodes and a plurality of network edges connecting two or more of the plurality of network nodes by processing one or more portions of the at least one graph representation using at least one graph network in connection with one or more processor-based spatial-temporal transformers, wherein two non-adjacent network nodes in the spatial-sequential graph network are connected in the spatial-sequential graph network based at least in part on one or more distance metrics relating to the two non-adjacent network nodes;
aggregating at least a plurality of the one or more encoded determined spatial relationships and the one or more encoded determined sequential relationships of the at least one graph representation into a spatial-sequential feature representation of the at least one digital file;
performing similarity detection for the at least one digital file relative to one or more additional digital files based at least in part on the spatial-sequential feature representation of the at least one digital file; and
initiating one or more automated data storage control actions based at least in part on a result of the similarity detection.

11. The non-transitory processor-readable storage medium of claim 10, further comprising adjusting a weight of at least one of the plurality of network edges in the spatial-sequential graph network based at least in part on one or more of (i) the similarity distance between at least two network nodes, associated with the at least one network edge, of the plurality of network nodes in the spatial-sequential graph network and (ii) the temporal distance between the at least two network nodes associated with the at least one network edge.

12. The non-transitory processor-readable storage medium of claim 10, further comprising merging at least one feature across a plurality of time steps in the spatial-sequential graph network.

13. The non-transitory processor-readable storage medium of claim 10, wherein the determining the one or more spatial relationships and the one or more sequential relationships associated with the plurality of portions within the at least one digital file comprises generating one or more sequential-aware k-dimensional trees representing one or more of the plurality of portions of the at least one digital file.

14. (canceled)

15. The non-transitory processor-readable storage medium of claim 10, wherein the performing the similarity detection for the at least one digital file relative to the one or more additional digital files comprises using one or more machine learning-based fuzzy similarity matching techniques.

16. An apparatus comprising:
at least one processing device comprising a processor coupled to a memory;
the at least one processing device being configured:
obtaining a plurality of portions of at least one digital file;
determining one or more spatial relationships and one or more sequential relationships associated with the plurality of portions within the at least one digital file;
generating at least one graph representation of at least portions of the at least one digital file based at least in part on the one or more determined spatial relationships within the at least one digital file and the one or more determined sequential relationships within the at least one digital file, wherein graph nodes in the at least one graph representation represent portions of the at least one digital file, wherein a given graph node is augmented with (i) one or more feature values derived from at least one hash value of the corresponding portion of the at least one digital file and (ii) a sequential position of the corresponding portion, and wherein a graph edge between at least two graph nodes encodes the one or more determined spatial relationships between the corresponding portions and the one or more determined sequential relationships between the corresponding portions;
encoding at least some of the one or more determined spatial relationships and at least some of the one or more determined sequential relationships from the at least one graph representation into a spatial-sequential graph network comprised of a plurality of network nodes and a plurality of network edges connecting two or more of the plurality of network nodes by processing one or more portions of the at least one graph representation using at least one graph network in connection with one or more processor-based spatial-temporal transformers, wherein two non-adjacent network nodes in the spatial-sequential graph network are connected in the spatial-sequential graph network based at least in part on one or more distance metrics relating to the two non-adjacent network nodes;
aggregating at least a plurality of the one or more encoded determined spatial relationships and the one or more encoded determined sequential relationships of the at least one graph representation into a spatial-sequential feature representation of the at least one digital file;
performing similarity detection for the at least one digital file relative to one or more additional digital files based at least in part on the spatial-sequential feature representation of the at least one digital file; and
initiating one or more automated data storage control actions based at least in part on a result of the similarity detection.

17. The apparatus of claim 16, further comprising adjusting a weight of at least one of the plurality of network edges in the spatial-sequential graph network based at least in part on one or more of (i) the similarity distance between at least two network nodes, associated with the at least one network edge, of the plurality of network nodes in the spatial-sequential graph network and (ii) the temporal distance between the at least two network nodes associated with the at least one network edge.

18. The apparatus of claim 16, further comprising merging at least one feature across a plurality of time steps in the spatial-sequential graph network.

19. The apparatus of claim 16, wherein the determining the one or more spatial relationships and the one or more sequential relationships associated with the plurality of portions within the at least one digital file comprises generating one or more sequential-aware k-dimensional trees representing one or more of the plurality of portions of the at least one digital file.

20. (canceled)

21. The non-transitory processor-readable storage medium of claim 10, wherein the performing the similarity detection for the at least one digital file relative to the one or more additional digital files comprises detecting similarities with respect to digital file content and at least one of digital file content structure and digital file content sequence.

22. The apparatus of claim 16, wherein the performing the similarity detection for the at least one digital file relative to the one or more additional digital files comprises using one or more machine learning-based fuzzy similarity matching techniques.

23. The apparatus of claim 16, wherein the performing the similarity detection for the at least one digital file relative to the one or more additional digital files comprises detecting similarities with respect to digital file content and at least one of digital file content structure and digital file content sequence.
